(19) United States
(12) Patent Application Publication
(10) Pub. No.: US 2021/0069612 A1
(43) Pub. Date: Mar. 11, 2021

(54) APPARATUS FOR CLARIFICATION OF CHEMICAL COMPOUNDS OF POROUS SILICA FROM AGRICULTURAL WASTE

(71) Applicant: Phoenix RRS, Panama (PA)

(72) Inventors: Froilan José Aguirre MONTILLA, Villa de Cura, Estado Aragua (VE); Jimmy Alfredo Castillo RIVAS, San Antonio de Los Altos, Estado Miranda (VE)

(21) Appl. No.: 16/568,145

(22) Filed: Sep. 11, 2019

(51) Int. Cl. B01D 15/20; B01J 20/10; B01J 20/34; B01J 20/30; B01D 15/16

(52) U.S. Cl. CPC B01D 15/20; B01J 20/103; B01J 20/3483; B01J 20/3071; B01D 15/161; B01J 20/3028; B01J 20/3092; B01D 15/163; B01J 20/3078

(57) ABSTRACT

An apparatus to clear and upgrade a quality of native or recovered compounds, paraffinic or naphthenic, and other hydrocarbons containing compounds or polar species, which are to be separated and to adsorb components responsible for dark appearance or darkening of recycling motor oil, vegetable and animal fatty acids through of porous silica obtained from agricultural waste, including a treatment with adsorbent, a porous silica obtained from agricultural waste; one or more containers with different volumes and geometric shape, according to needs of what is going to be treated, configured for the porous silica, the hydrocarbons and other compounds to be treated in contact; an element for temperature control of the mixture of the silica with the compound to be treated; an element for controlling pressure and flow of the mixture of the silica with the compound; and an element that filters and retains the adsorbent inside of the apparatus.

### BACKGROUND OF THE INVENTION

### Field of the Invention

This invention involves the design, construction and operating method of an apparatus that has been conceived to adsorb the components responsible for the dark appearance or darkening of virgin or recovered paraffinic, naphthenic and other hydrocarbons containing compounds or polar species, which are desired to be separated. As well as, to adsorb the components responsible for the dark appearance or the darkening of vegetable and animal fatty acids. The adsorbent is putting in contact with the compounds to be treated, in a container that can have different geometries and volumes, according to the quantity and characteristics thereof, under controlled conditions of pressure and temperature.

### Description of the Related Art

The quantities of many compounds of daily use, such as used motor oil and the fatty acids of animal or vegetable origin used, represent a serious problem in the environment due to its great polluting power, but also a great business opportunity if they could be recovered or regenerated with environmentally friendly technologies. Management of used motor oil is a big issue around the world. Only in the USA, 1.3 billion gallons/year are replaced, with up to 40% being recycled. Motor lube oils are classified into three categories: mineral, semi-synthetic and synthetic. Mineral oil contains up to 85% of recoverable oil base, as it keeps its properties. The oil base is recoverable by various means, including vacuum distillation, organic solvent treatment, catalytic hydrogenation, and acid extraction followed by adsorbent use. All these methods are widely known and documented in the literature. The first method, vacuum distillation, is extremely expensive. For its part, catalytic hydrogenation yields a high-quality base, but at a higher cost. Such method is impractical due to the high energy cost that comes with the process. The acid treatment with clay cleaning or solvent extraction and subsequent bleaching has substantially improved due to cutting-edge technology and the development of new materials with a higher adsorption capacity. The use of low-cost materials as an adsorbent opens up extensive prospects for treatment of used motor oil. U.S. Pat. No. 7,279,147B depicts a method to make an adsorbent from rice shells. Such absorbent results from the removal of silicate from the rice shell to produce, through chemical reaction, modified silica including calcium and magnesium ions. These new materials can absorb a large amount of impurities due to their great surface. While with endearing features, many of these nano-adsorbents are very difficult to make on an industrial scale, thus complicating their production and use. A newer patent, U.S. Pat. No. 9,403,688 B1, introduces a method to make silica nanoparticles of biogenic material. This method is good to produce the adsorbent materials of some other inventions.

Adsorption materials are solids able to adsorb a significant amount of some substances that need to be removed from the liquid or gaseous phase for the purpose of clearing. Such an adsorbent is widespread in the industry for purification of water, bleaching, and clearing of greases and oils. Particularly in the oil industry, several adsorbents have been used to recover used motor engine. Clay, bentonite and inorganic silicates are mostly used as adsorbents to bleach used motor oil, but with limited effectiveness.

Agricultural waste is a new source of silicon dioxide. Peanut shell, rice shell, bamboo leaves and sugarcane pulp are rich in silicon dioxide, for a 12-20% content of silica. Following heating, the waste material can yield 98% of silicon dioxide from amorphous to crystalline phases, depending on the applied treatment. The silicon dioxide resulting from agricultural waste is a source for adsorbents. Patents US2009/0065435 A1 and U.S. Pat. No. 9,403,688 B1 display biogenic silica. Both patents describe methods to attain silica nanoparticles based on a revision of prior endeavors (no-patent primary references). This invention is different from the previously described patents in terms of the silica production method. Here, silica does not come from chemical reaction, and the rice shell undergoes a prior treatment to prevent the formation of coal, thus removing ashes and achieving silica of 99.9% purity. In addition, in order to build the apparatus, certain amounts of silica with proper size and conditions are necessary for a good working order. For blend purification, a method was developed to maximize and upgrade the apparatus operation.

Vegetable oils, or vegetable fats, are fats extracted from seeds, or less often, from other parts of fruits. Like animal fats, vegetable fats are mixtures of triglycerides; soybean oil, rapeseed oil, and cocoa butter are examples of fats from seeds. Olive oil, palm oil, and rice bran oil are example of fats from other parts of fruits. Oil refining produces edible oil with characteristics that consumers desire such as bland flavor and odor, clear appearance, light color, stability to oxidation and suitability for frying, this refining is necessary for vegetable oils fats or animal oils & fats so they can be used for cooking and frying foods. The crude oil obtained from solvent extraction plant contains impurities. The refining process remove impurities, and make the oil edible, more palatable and stable against rancidity upon storage. The process of removing these impurities is called refining. One step of this process is the bleaching. The bleaching gently removes residual phosphatides, metals, soaps and oxidation products in addition to coloring matters. The feedstock is heated up in oil heater to degumming or bleaching temperature, in this step, the vegetable oil, feed stock, is fed directly to the bleacher after heating, bleaching earth and or activated carbon is mixed with the oil under vigorous agitation to avoid short cycling and provide necessary retention time before filtration.

### SUMMARY OF THE INVENTION

### Abstract

This invention involves the design and construction of an apparatus that has been designed to adsorb the components responsible for the dark appearance or darkening of virgin or recovered paraffinic, naphthenic and other hydrocarbons containing compounds or polar species, which are desired to be separated. As well as, to adsorb the components responsible for the dark appearance or the darkening of vegetable and animal fatty acids. The apparatus, wherein comprising: the adsorbent, an aggregates of nanoporous silica nanoparticles obtained from agricultural waste, are produced through a three-stage treatment. First stage includes acid leaching to remove every dirt and metal present in the waste material. Second stage comprises burning out and sintering, at temperatures ranging from 200° C. to 1200° C. Third stage includes grinding with a ball mill or a similar device to obtain aggregates of 0.1-40 micron, porous nanoparticles. The apparatus, which also comprises: one or more containers with different volumes and geometric shape, according to the needs of what is going to be treated, is configured for the porous silica, the hydrocarbons and other compounds to be treated are put in contact; element for temperature control of the mixture the silica with the compound to be treated; element for controlling the pressure and flow of the mixture the silica with the compound to be treated; element that filters and retains the adsorbent inside of the apparatus. The compound gets in touch with the adsorbent packing in a single or multiple containers for a reasonable period of time, sufficient to remove the impurities responsible for the dark appearance or the darkening. The final product, that is, the final product free of impurities or with very low levels of them, that leaves the container, is ready to be used as raw material for other processes.

An apparatus made of economical and environmentally-friendly material to treatment compounds containing chemical species or substances that give dark coloration, such as virgin or recovered mineral or synthetic oils, and new or used animal or vegetable fatty acids. The apparatus, which also comprises: one or more containers with different volumes and geometric shape, according to the needs of what is going to be treated, is configured for the adsorbent, the hydrocarbons and other compounds to be treated are put in contact. The adsorbent contained in the apparatus can be reused many times. The adsorbent is made of agricultural waste, as follows: the waste is leached with acid solution for 48 hours, dried up and burned out at 200° C.-1200° C. from ½ hour to 8 hours. Then, the material is ball milled and the particles larger than 40 microns are discarded. The adsorbent is packed in a container of a geometry suitable, the manufacturing plant design and sizes varying as appropriate for the compounds to be treated. The container is heated at temperatures that may range from 50° C. to 180° C. The compounds to be treated, is introduced in the container and put contact with the adsorbent for a certain time, depending on the physicochemical characteristics of the compound to be treated. The treated product is collected at the output. The adsorbent holds all the polar molecules present in the compounds to be treated. The adsorbent is regenerated under a subsequent treatment at temperatures from 200° C. to 1200° C., and held in a dry chamber until use.

The adsorbent preparation is economical and environmentally-friendly, including waste material as the primary source and low-cost treatment. The adsorbent is regenerated by washout and further heating, able to be used many times. This invention has many applications, as bleach used motor oil undergoing a recovery treatment, bleach paraffinic compounds with contents of aromatic pollutants and metals, clarification of vegetable oils, among others.

### BRIEF DESCRIPTION OF THE DRAWINGS

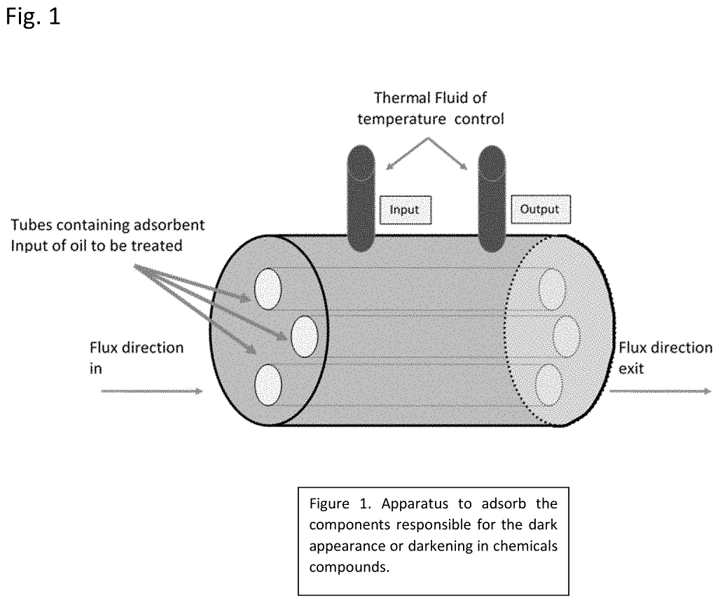

An embodiment of the present invention is illustrated in the accompanying drawings, by way of example. FIG. 1 is a schematic diagram of a sample system, made up of several cylindrical tubes, preferably metallic, with an inner diameter and a length, which can vary according to the needs of the compound to be treated. The metal tubes are located inside a temperature-controlled sleeve, whether through heat exchange by means of fluid recirculation or electric strength. The adsorbent is packed inside the metal tubes, and there they are put in contact, the adsorbent and the fluid to be treated, for the necessary time. The design of the system, the geometry and the dimensions vary according to the volume and the product to be treated.

### DETAILED DESCRIPTION OF THE PREFERRED EMBODIMENT

This invention is an economical and environmentally-friendly process to treated, purify and upgrade compounds that contain chemical species responsible for the dark appearance or the darkening in many chemicals compounds, particularly bleaching and upgrading the quality of native or recovered, paraffinic and naphthenic compounds, others currents from petrochemicals industries, and vegetable and animal fatty acids, like edibles vegetable oils, where in all of them there are polar species of different chemical nature, which need to be separated from the matrix in which they are found. The outcome is a substantially better color and a significant reduction of the content of polar species, sulfur and metals up to the level of traces. By way of example, FIG. 1 is a schematic diagram of the proposed sample system for bleaching. To simplify, in this case, the apparatus, which also comprises: one or more containers with different volumes and geometric shape, according to the needs of what is going to be treated, is configured for the porous silica, the compounds to be treated are put in contact; an element for temperature control; one element for controlling the pressure and flow; and one filtration element). The system can be tailor-made to the treated volume. The adsorbent is made as follows: a determinate quantity of agricultural waste (e.g.: peanut shell, rice shell, bamboo leaves and sugarcane pulp) are washed with distilled water to remove dirt. The solid is let to soak with enough volume of a solution to 15% of acid (hydrochloric acid, acetic acid, phosphoric acid and alike) for up to 48 hours to leach and remove all the metal content. The leached product is washed with distilled water to achieve pH 7 in the washout. The solid is dried up in a furnace for 6 hours. The solid is burned out in a furnace in two stages: first stage at 100° C.-400° C. for 4 hours, and second stage at 200° C.-1000° C. for 4 hours. The resulting solid is ball milled to yield a high dispersion solid from 10 nm to 40 microns. The solid is made of amorphous, highly porous silicon dioxide. The solid of such a size maintains a porous skeletal structure. This low-compaction skeletal structure with active groups inside helps trap small polar molecules, responsible for the dark appearance or the darkening in many chemicals compounds, e.g.: native or recovered, paraffinic and naphthenic compounds, others currents from petrochemicals industries, and vegetable and animal fatty acids, like edibles vegetable oils. The amorphous shape of silica does not cause silicosis, for easier handling and better care. The solid is held in a dry chamber until use. The sample system shown in FIG. 1 is filled with the adsorbent. The system may be heated at 50° C.-180° C.

What is claimed is:

1. An apparatus to clear and upgrade a quality of native or recovered compounds, paraffinic or naphthenic, and other hydrocarbons containing compounds or polar species, which are to be separated and to adsorb components responsible for dark appearance or darkening of recycling motor oil, vegetable and animal fatty acids through of porous silica obtained from agricultural waste, comprising:
an adsorbent comprising a porous silica obtained from agricultural waste;
one or more containers with different volumes and geometric shape, according to needs of what is going to be treated, configured for the porous silica, the hydrocarbons and other compounds to be treated in contact;
an element for temperature control of the mixture of the silica with the compound to be treated;
an element for controlling pressure and flow of the mixture of the silica with the compound to be treated; and
a filter configured to filter and retain the adsorbent inside the apparatus.

2. The apparatus of claim 1, wherein the porous silica or adsorbent, is prepared from the agricultural waste by a process comprising:
leaching the waste with acid solution;
drying and burning the waste at 200° C.-1200° C. for a period of from ½ hour to 8 hours;
ball milling the waste after it is dried and burnt;
discarding particles larger than about 40 microns to produce the adsorbent;
packing the adsorbent in a container of suitable geometry suitable.

3. The apparatus of claim 1, further comprising regenerating the porous silica with a subsequent thermic treatment at a temperature from about 200° C. to about 1200° C.

4. The apparatus of claim 2, wherein the leaching is conducted for a period of 2 to 168 hours.

5. The apparatus of claim 4, wherein the leaching is conducted for a period of 24 to 72 hours.
